(19) United States
(12) Patent Application Publication
(10) Pub. No.: US 2015/0116590 A1
(43) Pub. Date: Apr. 30, 2015

(54) Protective Apparatus with Temperature-Regulating Function for Video Camera

(71) Applicant: LonTrend Corporation, New Taipei City (TW)

(72) Inventors: Yu-Lin Huang, Taipei City (TW); Yuan-Ching Chiang, Taipei City (TW)

(73) Assignee: LonTrend Corporation, New Taipei City (TW)

(21) Appl. No.: 14/278,906

(22) Filed: May 15, 2014

(30) Foreign Application Priority Data
Oct. 25, 2013 (TW) 102219896

(51) Int. Cl. G03B 17/55; H04N 5/225

(52) U.S. Cl. CPC G03B 17/55; H04N 5/2252
USPC 348/373

(57) ABSTRACT

A protective apparatus with temperature-regulating function for protecting a camera is provided. The protective apparatus comprises a protective housing which includes a base, a protective cover and a heat storage unit. The base has a concave space for the camera disposed thereon. The protective cover has a concave structure assembling with the base to create a space for the camera disposed therein. The heat storage unit is disposed within the protective housing, with a cavity for storing at least one phase change material.

### TECHNICAL FIELD

The present invention generally relates to a protective apparatus for a camera, more particularly, to a protective apparatus and its assembly with temperature-regulating function for a camera.

### BACKGROUND

Most of the electronic components of the cameras are manufactured by using semiconductor processes, and usage life-span of such electronic components operating in high ambient temperature tends to reduce. However, in order to make cameras in harsh environmental conditions for usage, the protective housing of cameras need to have a higher level of waterproof and dustproof. Therefore, the traditional camera is designed to have a closed housing to achieve such purpose. That is, lenses, power supply and related components contained in the camera are usually installed in a protective housing, so that these electronic components are isolated from outside to achieve a higher level of waterproof and dustproof (for example, the Ingress Protection Rating, IP67, indicates that device can be immersed in water at depth of at least 1 m measured at bottom of device, and at least 15 cm measured at top of device and no ingress of dust, or IP68 means that device can be continuous immersed in water up to 3 m and no ingress of dust). While this may effectively protect electronic components, but can not efficiently spread the heat outside and thereby increasing the temperature within the housing. Thus, the heat transfer for the protective housing becomes a thorny issue. Therefore, it has become a challenge for the design of protective housing of camera that can not only provide better operating temperature conditions for cameras, but also be able to take into account the requirements of waterproof and dustproof.

Currently, manufacturers of protective housings for cameras use the following different solutions respectively, in order to solve the issues of heat dissipation for cameras in high ambient temperature.

(1) Using a built-in fan, the fan is engaged into the protective housing of a camera, with the fan blowing to improve the flow of air inside the protective housing. However, in order to achieve the level of waterproof and dustproof (IP67/IP68), the protective housing is usually designed with highly tightness. Therefore, the fan is only used to improve the coefficient of heat convection of the air flowing within the protective housing. The heat dissipation effect is more limited.

(2) Opening convection holes on a protective housing for a camera, so that air convection inside the protective housing flows to the external environment. The protective housing is unable to meet the level of waterproof and dustproof (IP67/IP68), and reduces its usage.

(3) Using a fan outside of a protective housing for a camera, the fan and a group of fins is engaged on external top of the protective housing, heat transferring from inside of the protective housing to surface of the protective housing, and then by the external fan blowing, heat dissipating away from surface of the fins via environmental air. The temperature inside the protective housing can not drop below the ambient temperature.

(4) Using liquid (such as water) cooling technology for a protective housing, a liquid cooling kit is engaged on external of or in the protective housing, the heat generated by the camera is taking away from the cooling kit through liquid cycling. However, disadvantage of this technique is higher cost of active components (pumps) for cooling required, and installation conditions limit to the need for cooling liquid.

(5) A technique utilizes a thermoelectric chip to control temperature within the protective housing. Disadvantage of this technique is higher cost and the power consumption is increased when the camera is operated.

### SUMMARY OF THE INVENTION

An objective of the invention is to provide a protective apparatus and its assembly with temperature-regulating function for a camera, whereby a phase change material providing the temperature inside the protective housing equivalent to or below the ambient temperature.

An objective of the invention is to maintain a good temperature regulation performance in a higher level of waterproof and dustproof.

Another object of the invention is to provide a protective apparatus with self temperature-regulating function, because the phase change material can be used to adjust the temperature within the enclosure without extra power.

According to an aspect of the invention, it proposes a protective apparatus with temperature-regulating function for a camera, comprising a protective housing, wherein the protective housing includes a base having a first end and a second end opposite to each other, wherein the base is used for carrying a camera. A protective cover is combined with the base to form an independent space for the camera disposed therein. At least one thermal energy storage unit is disposed on internal or external of the protective housing, wherein the at least one thermal energy storage unit has a cavity for filling with at least one phase change material.

In an aspect, the first end of the base has an opening to receive a transparent lens or a transparent glass.

In another aspect, the protective apparatus further comprises a demister disposed at the first end of the base to maintain visibility of the transparent lens or the transparent glass. A control circuit board is disposed on the base, electrically connected to the camera via a connection line.

In yet another aspect, the protective cover and the base is bonded to each other by silicone, rubber, gasket or seal ring configured on a joint area there-between, or by engaging or locking. The protective cover comprises an engagement portion and a pivot for facilitating engaging.

In one aspect, the protective apparatus further comprises a fan disposed inside of the protective housing to enhance the flow of air inside the protective housing. The thermal energy storage unit is disposed inside of the protective cover or on the protective cover.

In another aspect, the thermal energy storage unit is integrally formed with the protective cover. Thermal energy storage unit can absorb or release heat energy by the phase transition of the phase change material.

In yet another aspect, a housing of the thermal energy storage unit is a thermal conductivity material, such as aluminum, copper, silver, iron, nickel, titanium, or metal alloys thereof. The phase change material is paraffin wax, inorganic salts, salts water compound and mixtures thereof, acid, sugar alcohol groups, polyolefin, polyester of low molecular weight, epoxy resin of low molecular weight or acrylate of low molecular weight.

### BRIEF DESCRIPTION OF THE DRAWINGS

The components, characteristics and advantages of the present invention may be understood by the detailed descriptions of the preferred embodiments outlined in the specification and the drawings attached:

FIG. 1 illustrates a perspective view of the camera configured into the protective housing according to the first embodiment of the invention;

FIG. 2 illustrates a perspective view of the camera configured into the protective housing according to the second embodiment of the invention;

FIG. 3 illustrates a perspective view of the camera configured into the protective apparatus with temperature-regulating function according to the third embodiment of the invention; and

FIG. 4 illustrates a perspective view of the camera configured into the protective apparatus with temperature-regulating function according to the fourth embodiment of the invention.

### DETAILED DESCRIPTION

The present invention provides a protective apparatus with temperature-regulating function for a camera. Purpose of the invention proposes a protective apparatus with temperature-regulating function for a camera capable of operating under high ambient temperature (larger than 50 degrees Celsius) and meeting the required level of waterproof and dustproof (IP67/IP68). Under such operating conditions, temperature within the protective housing for a camera keeps below 50 degrees Celsius to maintain the performance and life-span of the camera, and to ensure the shooting quality (for example screen flashes, stop-motion, etc.) of the camera.

The protective apparatus for a camera comprises two parts, wherein the first part is protective housing, which is made of aluminum, and meet the level of waterproof and dustproof (IP67/IP68) (which may include a fan, a control circuit board), and the second part is thermal energy storage unit configured inside of the protective housing. The housing of the thermal energy storage unit can be made of copper, which has at least one cavity for filling with phase change material. When the ambient temperature rises, the temperature inside the protective housing for a camera will increase. When the temperature inside the protective housing for a camera is higher than the melting temperature of the phase change material, the thermal energy storage unit will store the heat inside the protective housing without increasing temperature. Meanwhile, the state of the phase change material will be changed from solid to liquid, and the phase change material absorbs heat inside the protective housing during the phase transition, such that temperature inside the protective housing for a camera is maintained in the melting temperature of the phase change material. The phase change material of the invention is for example paraffin wax, used to maintain the temperature inside the protective housing for a camera at about 47 degrees Celsius, which is available temperature of operating allowed for a camera, within the operating temperature range (40 to 50 degrees Celsius), to ensure the performance and lifetime of the camera. When the ambient temperature falls, the temperature inside the protective housing for a camera will drop. When the temperature inside the protective housing for a camera is lower than the melting temperature of the phase change material, the thermal energy storage unit releases heat energy. Meanwhile, the state of the phase change material will be changed from liquid to solid, and the phase change material releases latent heat inside the protective housing during the phase transition to the outside of the protective housing, until the state of phase change material returns to the original state (solid state).

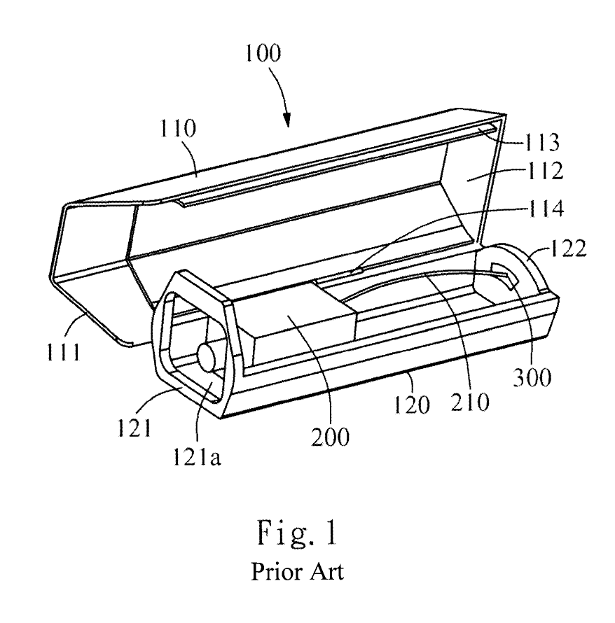

FIG. 1 shows a perspective view of a camera configured into a protective housing according to the first embodiment of the invention. As shown in FIG. 1, a protective housing 100 for a camera is used to protect a camera 200. For example, the protective housing 100 includes a base 120 and a protective cover 110. The base 120 is used for carrying the camera 200 therein. The camera 200 is provided, being fixed to the base 120, for example, by a locking screw member. In one embodiment, the camera 200 is for example an imaging device with different specifications, which can be used to capture dynamic continuous images or static discontinuous picture.

The base 120 has a first end 121 and a second end 122 opposite to each other, and a containing space. The first end 121 is a front end of the base 120 having an opening 121a to receive a transparent lens or a transparent glass. The transparent lens can be embedded into the opening 121a. In this embodiment, the transparent lens is closely adhering into the opening 121a of the first end 121. That is, the transparent lens is disposed at the first end 121 so that the camera can capture images in front of the first end 121 through the transparent lens. The second end 122 is a rear end of the base 120, and a control circuit board 300 is disposed onto the base 120, for example on the second end 122. The control circuit board 300 is electrically connected to an external power source and the camera 200. For example, the control circuit board 300 is electrically connected to the camera 200 via a connection line 210. In one example, the camera 200 receives electrical power provided by the external power source via the control circuit board 300, and transmits signal to outside of the camera via the control circuit board 300.

The protective cover 110 has a third end 111 and a fourth end 112 opposite to each other, an engagement portion 113 and a pivot 114, and the protective cover 110 has a concave structure. The protective cover 110 can be tightly combined with the base 120 to create a containing space, whereby the camera 200 is disposed in the containing space. In one embodiment, the protective cover 110 and the base 120 may be bonded and fixed to each other by silicone or seal ring configured on the joint area there-between, or by engaging or locking (using the engagement portion 113) to tightly combine and increase air tightness. The protective cover 110 can be rotated about its pivot 114 to facilitate combining with the base 120. When the protective cover 110 combines with the base 120, the third end of the protective cover 110 seals with the first end of the base 120, and the fourth end of the protective cover 110 seals with the second end of the base 120. In a preferred embodiment, the third end of the protective cover 110 is an open end to expose the first end of the base 120 to avoid blocking the transparent lens or the transparent glass.

In one embodiment, a fan is disposed inside the protective housing 100, with the fan blowing to improve flowing of air inside the protective housing 100, to enhance the heat transfer coefficient of convection air inside the protective housing 100. The field of view of the cameras 200 does not be affected by configuration of the fan.

In one embodiment, a demister (not shown) may be disposed at the first end 121 of the base 120, or at a position adjacent to the base 120 or the protective cover 110 to maintain visibility of the transparent lens. In one embodiment, a demister may be a heater. The heater may be entirely or partially attached onto the transparent lens without affecting the field of view of the camera 200, whereby eliminating mist condensed due to temperature difference between the inner and outer of transparent lens by heating.

In this embodiment, an illumination device (not shown) is disposed (placed) on the base 120 and electrically coupled to the control circuit board 300. The field of view of the cameras 200 does not be affected by configuration of the illumination device. In one example, the illumination device includes a light detection element and a light-emitting element. The light detection element is used to detect light source of the external environment, the light-emitting element is emitting based on the light intensity detected by the light detection element. When there is insufficient light, whereby the illumination device projected a beam toward front of the first end 121 of the base 120.

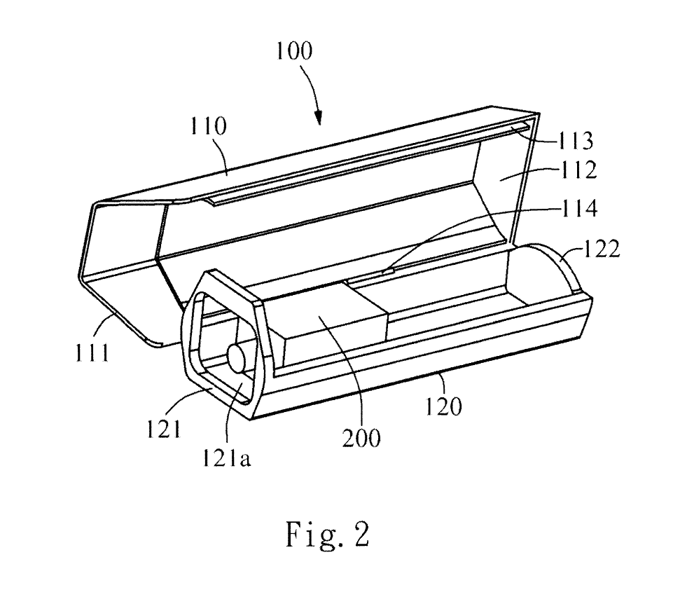

FIG. 2 shows a perspective view of a camera configured into the protective housing according to the second embodiment of the invention. In this embodiment, the control circuit board is integrated into the camera 200, so no connection line is required electrically connected to the camera 200. In one example, the camera 200 wirelessly transmits (such as using a wireless module) signal to the outside of the camera 200 by the control circuit board.

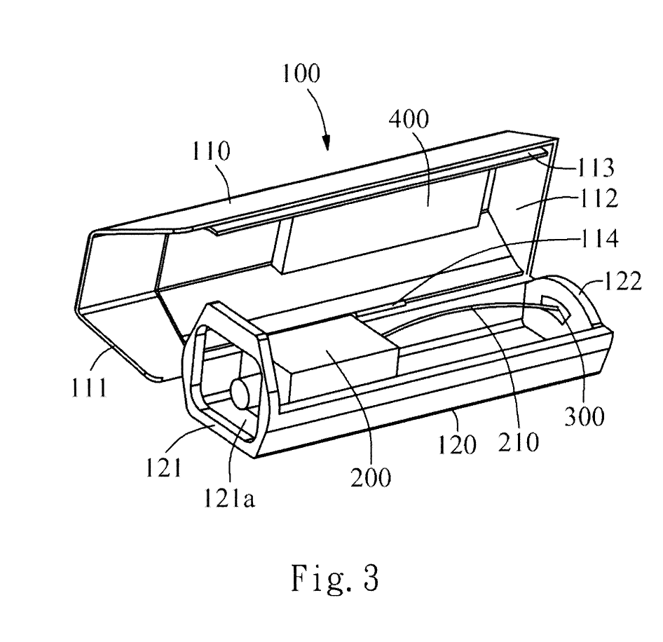

FIG. 3 shows a perspective view of a camera configured into the protective apparatus with temperature-regulating function according to the third embodiment of the invention. In this embodiment, at least one thermal energy storage unit 400 is disposed on internal or external of the protective housing 100. For example, the thermal energy storage unit 400 is disposed on the internal of the protective cover 110 or at a suitable position in the internal of the protective housing 100. For example, housing of the thermal energy storage unit 400 can be made of copper, which has at least one cavity for filling with phase change material. The thermal energy storage unit 400 can be attached onto the protective cover 110 or integrally formed with the protective cover 110. The thermal energy storage unit 400 and the protective cover 110 are formed by a die-casting or injection molding process. The housing of thermal energy storage unit 400 can be made of thermal conductivity material, such as aluminum, copper, silver, iron, nickel, titanium, or metal alloys thereof. The phase change material may be selected from paraffin wax (such as parafin C16-C18, parafin C16-C28, parafin C20-C33, parafin C22-C45), polyglycols, alkanes, inorganic salts, salts water compound and mixtures thereof, acid, fatty acids (such as capric acid, auric acid, myristic acid, palmitic acid, straric acid . . . ), salt solution, salt hydrate, sugar alcohol groups, polyolefin, polyester of low molecular weight, epoxy resin of low molecular weight or acrylate of low molecular weight; and the present embodiment employs paraffin wax.

When the ambient temperature rises, the temperature inside the protective housing 100 will increase. When the temperature inside the protective housing 100 is higher than the phase transition temperature (such as melting temperature) of the phase change material, the thermal energy storage unit 400 will store heat energy, and thereby changing the state of the phase change material. Meanwhile, the phase change material absorbs heat inside the protective housing 100 during the phase transition, such that temperature inside the protective housing 100 maintains the phase transition temperature of the phase change material based on the selected phase change material. Filling amount of the phase change material and size of the thermal energy storage unit 400 may be adjusted according to actual applications. The phase change material of this embodiment is paraffin wax, used to maintain the temperature inside the protective housing 100 at about 47 degrees Celsius, which is available temperature of operating allowed for the camera 200, within the operating temperature range (40 to 50 degrees Celsius), to ensure availably operating the camera 200 in the containing space, and enhance the performance and life-span of the camera 200. When the ambient temperature outside of the protective housing 100 falls, the temperature inside the protective housing 100 will drop. When the temperature inside the protective housing 100 is lower than the melting temperature of the phase change material, the thermal energy storage unit 400 releases heat energy until the state of the phase change material returns to the original state (solid state).

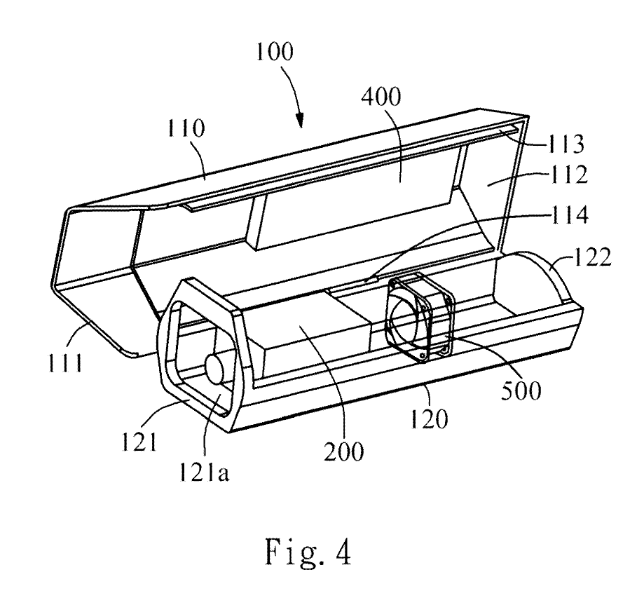

FIG. 4 shows a perspective view of a camera configured into a protective housing with temperature-regulating function according to the fourth embodiment of the invention. In this embodiment, a fan 500 is disposed inside the protective housing 100, for example within the base 120, with the fan 500 blowing to improve flowing of air inside the protective housing 100, to enhance the heat transfer coefficient of convection air inside the protective housing 100. The field of view of the camera 200 does not be affected by configuration of the fan 500.

The foregoing descriptions are preferred embodiments of the present invention. As is understood by a person skilled in the art, the aforementioned preferred embodiments of the present invention are illustrative of the present invention rather than limiting the present invention. The present invention is intended to cover various modifications and similar arrangements included within the spirit and scope of the appended claims, the scope of which should be accorded the broadest interpretation so as to encompass all such modifications and similar structures.

What is claimed is:

1. A protective apparatus with temperature-regulating function for a camera, comprising:
a protective housing, wherein said protective housing includes:
a base having a first end and a second end opposite to each other, wherein said base is used for carrying a camera;
a protective cover combined with said base to form an independent space for said camera disposed therein; and
at least one thermal energy storage unit disposed on internal or external of said protective housing, wherein said at least one thermal energy storage unit is filled with at least one phase change material, wherein said phase change material is paraffin, polyglycol, alkane, wax, or the combination thereof.

2. The protective apparatus of claim 1, wherein said first end of said base has an opening to receive a transparent lens or a transparent glass.

3. The protective apparatus of claim 2, further comprising a demister disposed at said first end of said base to maintain visibility of said transparent lens or said transparent glass.

4. The protective apparatus of claim 3, wherein said demister is a heater.

5. The protective apparatus of claim 4, wherein said heater is entirely or partially attached onto said transparent lens or said transparent glass.

6. The protective apparatus of claim 5, further comprising a control circuit board disposed on said base.

7. The protective apparatus of claim 6, further comprising an illumination device disposed on said base electrically coupled to said control circuit board.

8. The protective apparatus of claim 7, wherein said illumination device includes a light detection element and a light-emitting element.

9. The protective apparatus of claim 1, wherein said protective cover and said base is bonded to each other by silicone, rubber, gasket or seal ring configured on a joint area there-between.

10. The protective apparatus of claim 1, wherein said protective cover and said base is bonded to each other by engaging or locking.

11. The protective apparatus of claim 1, wherein said protective cover comprises an engagement portion and a pivot.

12. The protective apparatus of claim 1, further comprising a fan disposed inside of said protective housing.

13. The protective apparatus of claim 1, further comprising a control circuit board configured on said base, and a wireless module electrically connected to said control circuit board.

14. The protective apparatus of claim 1, wherein a housing of said thermal energy storage unit is made of aluminum, copper, silver, iron, nickel, titanium, or metal alloys thereof.

15. The protective apparatus of claim 1, wherein phase change material may be further selected from inorganic salts, salts water compound and mixtures thereof, acid, sugar alcohol groups, polyolefin, polyester of low molecular weight, epoxy resin of low molecular weight or acrylate of low molecular weight.

16. The protective apparatus of claim 1, wherein said paraffin includes parafin C16-C18, parafin C16-C28, parafin C20-C33, or parafin C22-C45.
